(19) United States
(12) Patent Application Publication
(10) Pub. No.: US 2015/0034454 A1
(43) Pub. Date: Feb. 5, 2015

(54) SUBSTRATE TRANSFERRING APPARATUS

(71) Applicant: Samsung Display Co., Ltd., Yongin-City (KR)

(72) Inventors: Soon-Ju PARK, Asan-si (KR); Sung-Hun KIM, Asan-si (KR); Yoon-Won KIM, Asan-si (KR); Young-Gil PARK, Yongin-si (KR); Jung-Ho PARK, Asan-si (KR); Mun-Gu BAEK, Suwon-si (KR); Young-Bok YOON, Asan-si (KR); Sung-Soo LEE, Asan-si (KR); Byoung-Yun JOO, Asan-si (KR); Bong-Soo CHOI, Osan-si (KR)

(21) Appl. No.: 14/450,439

(22) Filed: Aug. 4, 2014

(30) Foreign Application Priority Data
Aug. 5, 2013 (KR) 10-2013-0092604

(51) Int. Cl. B65G 37/00; B65G 13/00

(52) U.S. Cl. CPC B65G 37/00; B65G 13/00
USPC 198/610

(57) ABSTRACT

A substrate transferring apparatus includes a first conveyer line assembly which transfers a substrate in a first direction, and includes a first base frame extending along the first direction, first and second pulleys respectively disposed at both end parts of the first base frame in the first direction, and a conveyer belt disposed on the first base frame, and driven by the first and second pulleys, and a first roller line assembly spaced apart from the first conveyer line assembly in a second direction which is substantially perpendicular to the first direction, and including a second base frame extending along the first direction, and a first roller part connected to the second base frame and including a plurality of rollers which contacts to the substrate.

This application claims priority to Korean Patent Application No. 10-2013-0092604, filed on Aug. 5, 2013, and all the benefits accruing therefrom under 35 U.S.C. § 119, the contents of which are incorporated by reference herein in its entirety.

### BACKGROUND

1. Field

Exemplary embodiments of the invention relate to a substrate transferring apparatus.

More particularly, exemplary embodiments of the invention relate to a substrate transferring apparatus for transferring a substrate for manufacturing a display apparatus.

2. Description of the Related Art

Generally, a substrate transferring apparatus for transferring a substrate for a display panel transfers the substrate using a conveyer belt. A protecting film protecting the substrate is attached on a surface of the substrate. Before transferring the substrate, the protecting film may be removed for manufacturing process.

### SUMMARY

It is important to effectively prevent a substrate from being damaged during a transferring process, because damage on the substrate directly influences to yield rate. A traditional substrate transferring apparatus has a problem with regard to the damage on the substrate according to a damaged conveyer belt.

One or more exemplary embodiment of the invention provides a substrate transferring apparatus capable of decreasing damage to a substrate.

According to an exemplary embodiment of the invention, a substrate transferring apparatus includes a first conveyer line assembly which transfers a substrate in a first direction, and a first roller line assembly spaced apart from the first conveyer line assembly in a second direction which is substantially perpendicular to the first direction. The first conveyer line assembly includes a first base frame extending along the first direction, first and second pulleys respectively disposed at both end parts of the first base frame in the first direction, and a conveyer belt disposed on the first base frame and driven by the first and second pulleys. The first roller line assembly includes a second base frame extending along the first direction, and a first roller part connected to the second base frame and comprising a plurality of rollers which contacts the substrate.

In an exemplary embodiment, the substrate transferring apparatus may further include second to fourth conveyer line assemblies spaced apart from the first conveyer line assembly in the second direction, and second to fourth roller line assemblies spaced apart from the first roller line assembly in the second direction.

In an exemplary embodiment, each of the second to fourth conveyer line assemblies may include he first base frame, the first and second pulleys and the conveyer belt. Each of the second to fourth roller line assemblies may include the second base frame and the first roller part.

In an exemplary embodiment, the first and second conveyer line assemblies may be disposed directly adjacent to each other as a pair. The third and fourth conveyer line assemblies may be disposed directly adjacent to each other as a pair. The first to fourth roller line assemblies may be disposed between the pair of the first and second conveyer line assemblies and the pair of the third and fourth conveyer line assemblies.

In an exemplary embodiment, the substrate transferring apparatus may further include a working part which removes protecting films on top and bottom surfaces of the substrate. The substrate without the protecting films may be transferred by the first to fourth conveyer line assemblies.

In an exemplary embodiment, the first roller part of the first roller line assembly may further include the plurality of rollers arranged in the first direction, a roller supporting part disposed adjacent to the second base frame, and extending along the first direction, and a connecting part connecting the roller supporting part to the second base frame.

In an exemplary embodiment, the first roller line assembly may further include a second roller part opposite to the first roller part with reference to the second base frame. The second roller part may include the plurality of rollers, the roller supporting part and the connecting part.

In an exemplary embodiment, the substrate transferring apparatus may further include a loading part disposed adjacent to the conveyer line assembly in the first direction, and an un-loading part disposed opposite to the loading part with reference to the conveyer line assembly and adjacent to the conveyer line assembly. The substrate may be transferred in an order of the loading part, the first conveyer line assembly and the un-loading part.

In an exemplary embodiment, the substrate transferring apparatus may further include an ionizer which supplies ion to the substrate.

In an exemplary embodiment, the substrate transferring apparatus may further include an electrostatic discharge wire disposed between the loading part and the first conveyer line assembly, and spaced apart from a bottom surface of the substrate. The electrostatic discharge wire may extend in the second direction corresponding to a length of the substrate in the second direction, and may include an electro-conductive fiber or anti-static fiber.

In an exemplary embodiment, the plurality of rollers of the first roller part of the first roller line assembly may be idle rollers.

In an exemplary embodiment, each of the plurality of rollers may include a contacting part surrounding the roller and contacting with the substrate. The contacting part may include ultra-high-molecular-weight polyethylene (“UHMW-PE”).

In an exemplary embodiment, each of the plurality of rollers may include an inner-side portion having a rotational axis, an outer-side portion surrounding the inner-side portion, and a plurality of ball bearings disposed between the inner-side portion and the outer-side portion.

In an exemplary embodiment, the first base frame of the first conveyer line assembly and the second base frame of the first roller line assembly may be substantially same as each other.

In an exemplary embodiment, the first roller line assembly may further include a combining groove disposed in the second base frame, a combining hole defined through the connecting part, and a combining element combined with the combining groove through the combining hole, and configured to fix the connecting part to the second base frame.

In an exemplary embodiment, an adjusting groove may be defined in a surface of the connecting part which contacts to the roller supporting part. An adjusting hole may be defined through the roller supporting part. The roller supporting part combining element may be combined with the adjusting groove through the adjusting hole, and configured to fix the roller supporting part to the connecting part.

In an exemplary embodiment, the adjusting hole may have a long side in a third direction which is substantially perpendicular to the first and second directions.

In an exemplary embodiment, the first conveyer line assembly may further include a conveyer guide dispose between the first base frame and the conveyer belt to prevent the conveyer belt from leaving.

In an exemplary embodiment, a combining hole may be defined through the conveyer guide, and the conveyer guide may include a combining element combined with a combining groove of the first base frame through the combining hole of the conveyer guide.

In an exemplary embodiment, the conveyer guide may further include guide protrusions provided adjacent to both end parts of the conveyer belt in the second direction to prevent the conveyer belt from being leaving from the conveyer guide in the second direction.

According to the invention, a substrate transferring apparatus may include an electrostatic discharge wire and/or an ionizer. Thus, static electricity disposed on the substrate may be effectively prevented.

In an exemplary embodiment, the substrate transferring apparatus may include a plurality of roller line assemblies, so that damage to the substrate by a conveyer belt may be decreased.

In an exemplary embodiment, the roller line assembly may be disposed in the middle portion of the transferring part, so that a portion of the substrate not contacting the conveyer belt may be maximized

In an exemplary embodiment, the conveyer line assembly and the roller line assembly may be converted each other, due to a parts sharing.

In an exemplary embodiment, rollers of the roller line assembly may include an anti-static material to decrease static electricity and damage on the substrate.

In an exemplary embodiment, the rollers may have a ball bearing structure to decrease slip on the substrate.

In an exemplary embodiment, positions of the rollers of the roller line assembly may be adjusted by an adjusting groove of a connecting part, an adjusting hole of a roller supporting part and a roller supporting part combining element, so that the rollers may uniformly contact to the substrate.

### BRIEF DESCRIPTION OF THE DRAWINGS

The above and other features of the invention will become more apparent by describing in detail exemplary embodiments thereof with reference to the accompanying drawings, in which:

FIG. 1 is a plan view illustrating an exemplary embodiment of a substrate transferring apparatus according to the invention;

FIG. 2 is a side view of the substrate transferring apparatus of FIG. 1;

FIG. 3 is a plan view illustrating a transferring part of the substrate transferring apparatus of FIG. 1;

FIG. 4 is a plan view illustrating another exemplary embodiment of a transferring part of a substrate transferring apparatus according to the invention;

FIG. 5 is a plan view illustrating another exemplary embodiment of a transferring part of a substrate transferring apparatus according to still the invention;

FIG. 6 is a perspective view partially illustrating an exemplary embodiment of a conveyer line assembly of a substrate transferring apparatus according to the invention;

FIG. 7 is a cross-sectional view taken along line I-I′ of FIG. 6;

FIG. 8 is a perspective view partially illustrating an exemplary embodiment of a roller line assembly of a substrate transferring apparatus according to the invention;

FIG. 9 is a side view of a roller of FIG. 8;

FIG. 10 is a cross-sectional view taken along line II-II′ of FIG. 8; and

FIG. 11 is an exploded perspective view partially illustrating the roller line assembly of FIG. 8.

### DETAILED DESCRIPTION

Hereinafter, the invention will be explained in detail with reference to the accompanying drawings.

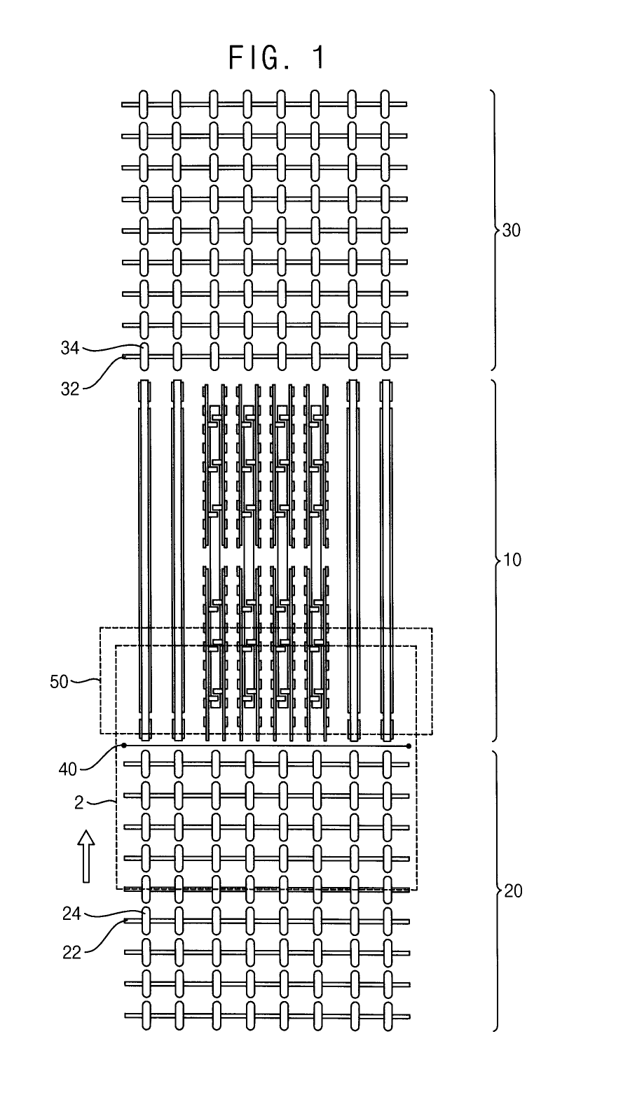

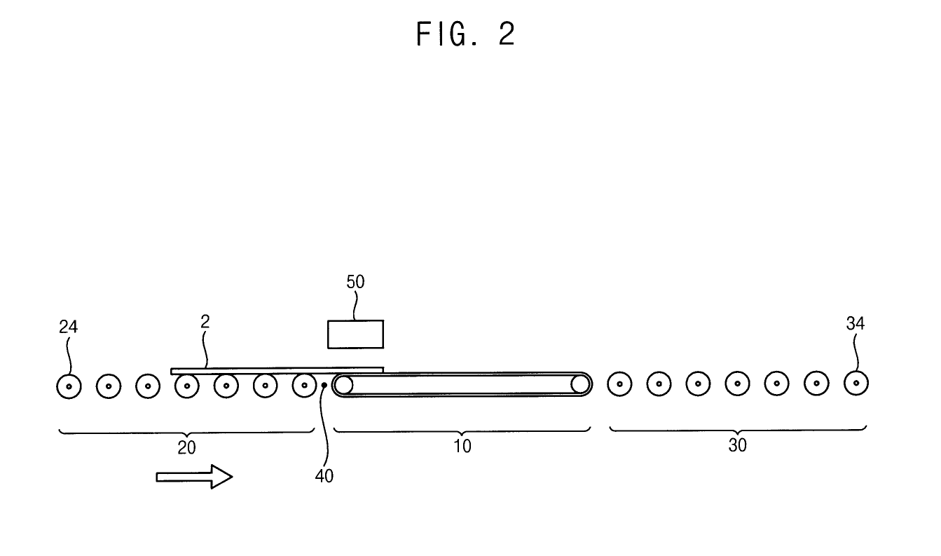

FIG. 1 is a plan view illustrating a substrate transferring apparatus according to an exemplary embodiment of the invention. FIG. 2 is a side view of the substrate transferring apparatus of FIG. 1.

Referring to FIGS. 1 and 2, a substrate transferring apparatus includes a transferring part 10, a loading part 20 and an un-loading part 30. The substrate transferring apparatus further includes an electrostatic discharge wire 40 and a working part 50.

The transferring part 10 transfers a substrate 2 along an arrow direction in the figure.

The substrate 2 may be an insulating substrate including insulating material such as a glass, a quartz, a resin and etc. In an exemplary embodiment, the substrate 2 may include a glass substrate used for a liquid crystal display (“LCD”) apparatus. The substrate 2 may further include a protecting film (not shown) attached on a top surface or a bottom surface of the substrate 2. The protecting film may be removed while the substrate 2 passes through the transferring part 10, or may be removed before the substrate 2 being reached to the transferring part 10. In an exemplary embodiment, the protecting film on the top surface of the substrate 2 may be removed by the working part 50. In addition, the protecting film on the bottom surface of the substrate 2 may be removed by another working part (not shown) disposed under the substrate 2.

The loading part 20 is disposed adjacent to the transferring part 10. The substrate 2 may be transferred from the loading part 20 to the transferring part 10 (refers to an arrow in FIG. 1). The loading part 20 includes a plurality of rollers 24 and a plurality of rotation axes 22 penetrating the rollers 24. The rotation axis 22 extends in a direction perpendicular to a transferring direction of the substrate 2 (refers to the arrow in FIG. 1). The rotation axes 22 are arranged in the transferring direction of the substrate 2, and spaced apart from each other.

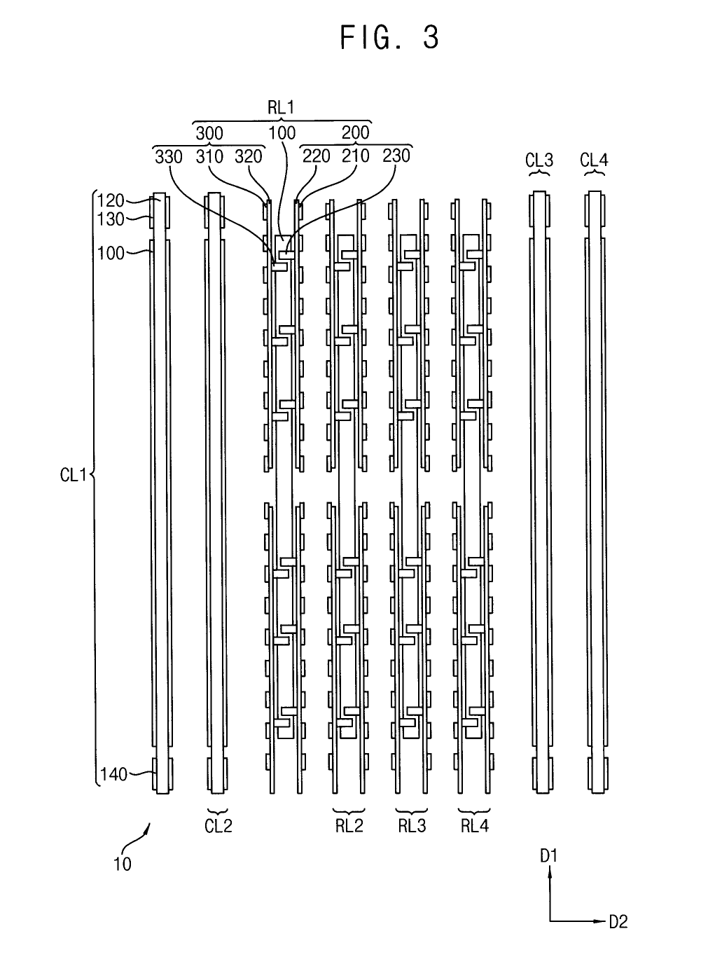

The rollers 24 of the loading part 20 may be idle rollers. Thus, the rollers 24 do not have driving force, but the rollers 24 may be rotated by an external force. In an exemplary embodiment, the substrate 2 may be laid on the loading part 20 by an additional transferring robot (not shown), for example. However, the invention is not limited thereto and the substrate 2 may be laid on the loading part 20 using various other methods. In an exemplary embodiment, the substrate 2 may be transferred by conveyer line assemblies CL1 to CL4 (refers to FIG. 3) of the transferring part 10 toward the transferring part 10.

The un-loading part 30 is disposed adjacent to the transferring part 10. The un-loading part 30 is disposed opposite to the loading part 20 with reference to the transferring part 10. The substrate 2 may be transferred form the transferring part 10 to the un-loading part 30 (refers to the arrow in FIG. 1). The un-loading part 30 includes a plurality of rollers 34 and a plurality of rotation axes 32 penetrating the rollers 34. The rotation axis 32 extends in a direction perpendicular to a transferring direction of the substrate 2 (refers to the arrow in FIG. 1). The rotation axes 32 are arranged in the transferring direction of the substrate 2, and spaced apart from each other.

The rollers 34 of the un-loading part 30 may be idle rollers. Thus, the rollers 34 do not have driving force, but the rollers 34 may be rotated by an external force. The substrate 2 may be transferred by conveyer line assemblies CL1 to CL4 (refers to FIG. 3) of the transferring part 10 from the transferring part 10 to the un-loading part 30, so that the substrate 2 may be laid on the un-loading part 30. In an exemplary embodiment, the substrate 2 on the un-loading part 30 may be transferred by an additional transferring robot (not shown), for example. However, the invention is not limited thereto and the substrate 2 on the un-loading part 30 may be transferred using various other methods.

The electrostatic discharge wire 40 is disposed between the loading part 20 and the transferring part 10. The electrostatic discharge wire 40 is disposed under the substrate 2 and spaced apart from the substrate 2. The electrostatic discharge wire 40 may protect the substrate 2 from electrostatic. In an exemplary embodiment, the electrostatic discharge wire 40 may include an electro-conductive fiber including a metal, a metal compound, and/or a carbon or an anti-static fiber including a compound, a carbon microparticle and/or a hydrophilic film, for example.

The working part 50 is disposed in the transferring part 10, so that the working part 50 performs various processes to the substrate 2 on the transferring part 10. In an exemplary embodiment, the working part 50 may remove a protecting film attached on a surface of the substrate 2, for example. The working part 50 may include a film removing tape. The film removing tape may be attached on the protecting film and then being removed from the substrate 2 with the protecting film, so that the protecting film may be removed from the substrate 2. In addition, the working part 50 may be disposed under the transferring part 10 (refers a position of 40 in the figure), so that a protecting film attached on a bottom surface of the substrate 2 is removed.

In an exemplary embodiment, the working part 50 may further include an ionizer generating ion. The ionizer supplies the ion to the substrate 2. Thus, electrostatic on the substrate 2 may be effectively prevented.

The substrate transferring apparatus according to the exemplary embodiment may include the electrostatic discharge wire 40 and/or the ionizer. Thus, electrostatic on the substrate 2 transferred by the substrate transferring apparatus may be effectively prevented.

FIG. 3 is a plan view illustrating a transferring part 10 of the substrate transferring apparatus according to FIG. 1.

Referring to FIG. 3, a transferring part 10 includes first to fourth conveyer line assemblies CL1, CL2, CL3 and CL4, and first to fourth roller line assemblies RL1, RL2, RL3 and LR4.

The first to fourth conveyer line assemblies CL1, CL2, CL3 and CL4 are arranged in a second direction D2 substantially perpendicular to a first direction D1, and disposed at boundaries of the transferring part 10. A substrate 2 (refers to FIG. 1) is transferred in the first direction. The first to fourth conveyer line assemblies CL1, CL2, CL3 and CL4 are disposed at the boundaries of the transferring part 10, so that contacting portions where the substrate 2 contacts conveyer belt 120 of the first and second conveyer line assemblies CL1 and CL2 may be disposed adjacent each other, and the third and fourth conveyer line assemblies CL3 and CL4 may be disposed adjacent each other. Thus, a portion of the substrate 2 not contacting the conveyer belt 120 may be maximized, so that undamaged area of the substrate 2 may be maximized although the conveyer belt 120 damages the substrate 2 by contact.

The first to fourth roller line assemblies RL1, RL2, RL3 and RL4 are disposed in a middle portion of the transferring part 10. The first to fourth roller line assemblies RL1, RL2, RL3 and RL4 are disposed in the middle portion of the transferring part 10, so that a portion of the substrate 2 not contacting the conveyer belt 120 may be maximized. Thus, undamaged area of the substrate 2 may be maximized although the conveyer belt 120 damages the substrate 2 by contact.

Accordingly, the first conveyer line assembly CL1, the second conveyer line assembly CL2, the first roller line assembly RL1, the second roller line assembly RL2, the third roller line assembly RL3, the fourth roller line assembly RL4, the third conveyer line assembly CL3 and the fourth conveyer line assembly CL4 may be disposed in a regular sequence in the second direction D2.

The first conveyer line assembly CL1 includes a base frame 100, a conveyer belt 120, a first pulley 130 and a second pulley 140.

The base frame 100 extends in the first direction Dl. The first pulley 130 and the second pulley 140 are disposed at both end parts of the base frame 100 in the first direction D1. The conveyer belt 120 is disposed on the base frame 100. The conveyer belt 120 is driven by the first and second pulleys 130 and 140. The substrate 2 disposed on the conveyer belt 120 is transferred along the first direction D1, as the conveyer belt 120 is driven by the first and second pulleys 130 and 140.

The first conveyer line assembly CL1 may further include a tension maintaining part maintaining tension of the conveyer belt 120.

Each of the second to fourth conveyer line assemblies CL2, CL3 and CL4 is substantially same as the first conveyer line assembly CL1.

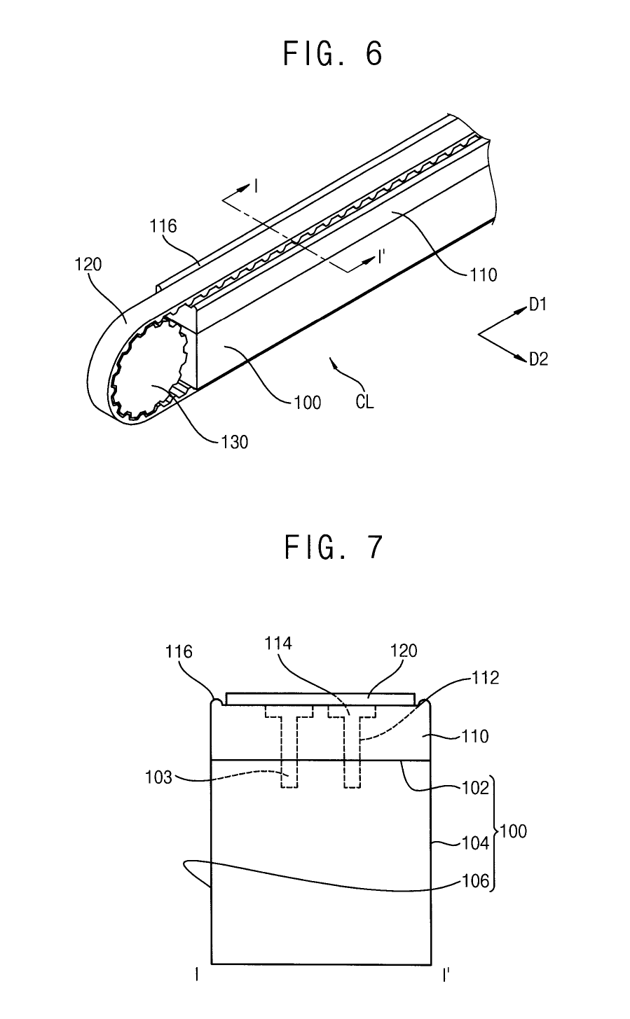

Each of the first to fourth conveyer line assemblies CL1 to CL4 is substantially same as a conveyer line assembly of FIG. 6. Thus, detailed explanation will be mentioned in FIG. 6.

The first roller line assembly RL1 includes a base frame 100, a first roller part 200 and a second roller part 300.

The base frame 100 extends in a first direction Dl. The first roller part 200 may be disposed adjacent to the base frame 100. The first roller part 200 includes a plurality of rollers 210, a supporting part 220 supporting the rollers 210, and a connecting part 230 connecting the supporting part 220 to the base frame 100. The plurality of rollers 210 and the supporting part 220 are parallel to the base frame 100 in a plan view.

The rollers 210 are arranged in the first direction D1, so that the substrate 2 may be transferred along the first direction Dl. The rollers 210 may be idle rollers. Thus, the rollers 210 may not have driving force, but may be rotated by an external force. In an exemplary embodiment, the rollers 210 may contact to the substrate 2, and the first to fourth conveyer line assemblies CL1 to CL4 transfer the substrate 2, so that the rollers 210 may be rotated.

The second roller part 300 is disposed on the base frame 100. The second roller part 300 includes a plurality of rollers 310, a supporting part 320 supporting the rollers 310, and a connecting part 330 connecting the supporting part 320 to the base frame 100. The plurality of rollers 310 and the supporting part 320 are disposed opposite to the first roller part 200 with reference to the base frame 100 in the plan view. The connecting part 230 and 330 may be alternately disposed along the first direction D1 in the plan view.

The rollers 310 are arranged in the first direction D1, so that the substrate 2 may be transferred along the first direction Dl. The rollers 310 may be idle rollers. Thus, the rollers 310 may not have driving force, but may be rotated by an external force. In an exemplary embodiment, the rollers 310 may contact to the substrate 2, and the first to fourth conveyer line assemblies CL1 to CL4 transfer the substrate 2, so that the rollers 310 may be rotated.

Each of the second to fourth roller line assemblies RL2, RL3 and RL4 is substantially same as the first roller line assembly RL1.

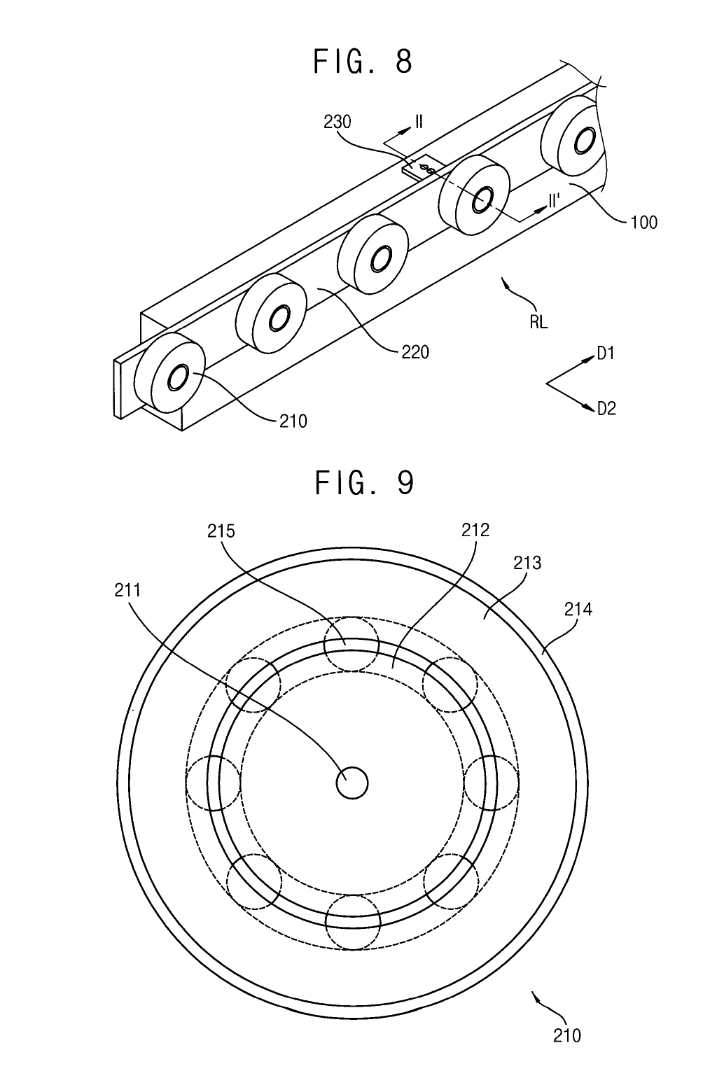

Each of the first to fourth roller line assemblies RL1 to RL4 is substantially same as a roller line assembly of FIG. 8. Thus, detailed explanation will be mentioned in FIG. 8.

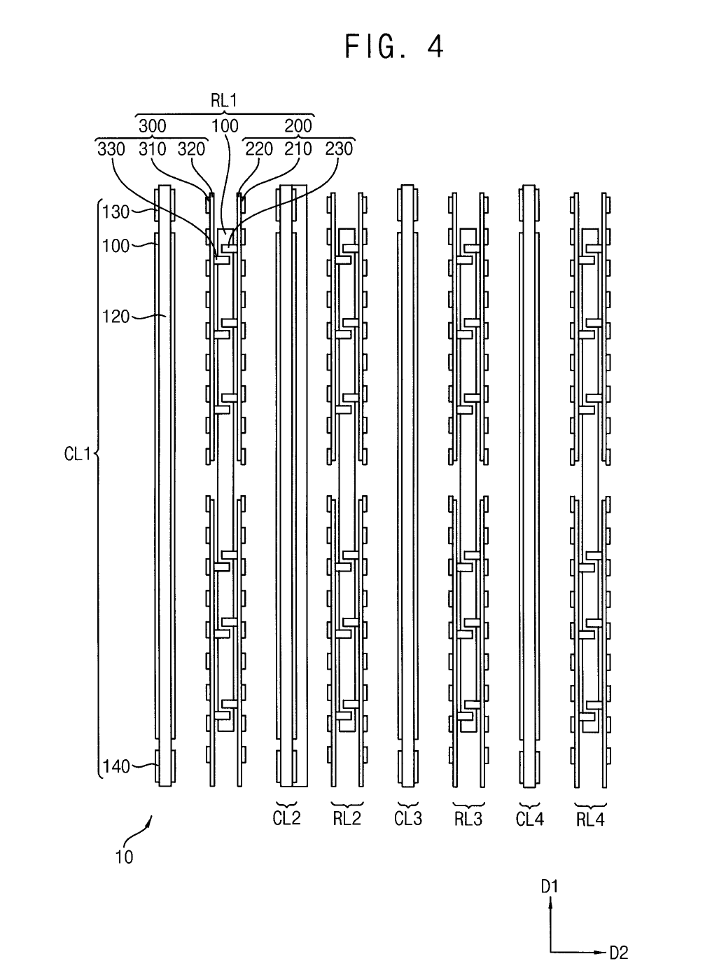

FIG. 4 is a plan view illustrating a transferring part 10 of a substrate transferring apparatus according to another exemplary embodiment of the invention.

Referring to FIG. 4, a transferring part 10 includes first to fourth conveyer line assemblies CL1, CL2, CL3 and CL4, and first to fourth roller line assemblies RL1, RL2, RL3 and RL4. The transferring part 10 is substantially same as a transferring part 10 of FIG. 3 except for an order of placement of the first to fourth conveyer line assemblies CL1, CL2, CL3 and CL4, and the first to fourth roller line assemblies RL1, RL2, RL3 and RL4 in the second direction D2. Thus, any further detailed descriptions concerning the same elements will be omitted.

The first to fourth conveyer line assemblies CL1, CL2, CL3 and CL4, and the first to fourth roller line assemblies RL1, RL2, RL3 and RL4 are alternately arranged in the second direction D2 substantially perpendicular to the first direction D1 which is a transferring direction of a substrate 2 (refers to FIG. 1). Thus, the first conveyer line assembly CL1, the first roller line assembly RL1, the second conveyer line assembly CL2, the second roller line assembly RL2, the third conveyer line assembly CL3, the third roller line assembly RL3, the fourth conveyer line assembly CL4 and the fourth roller line assembly RL4 may be sequentially disposed in the second direction D2.

The first conveyer line assembly CL1 includes a base frame 100, a conveyer belt 120, a first pulley 130 and a second pulley 140.

The base frame 100 extends in the first direction Dl. The first pulley 130 and the second pulley 140 are disposed at both end parts of the base frame 100 in the first direction Dl. The conveyer belt 120 is driven by the first and second pulleys 130 and 140. The substrate 2 disposed on the conveyer belt 120 is transferred along the first direction D1, as the conveyer belt 120 is driven by the first and second pulleys 130 and 140.

The first roller line assembly RL1 includes a base frame 100, a first roller part 200 and a second roller part 300.

The base frame 100 extends in a first direction Dl. The first roller part 200 may be disposed adjacent to the base frame 100. The first roller part 200 includes a plurality of rollers 210, a supporting part 220 supporting the rollers 210, and a connecting part 230 connecting the supporting part 220 to the base frame 100. The plurality of rollers 210 and the supporting part 220 are parallel to the base frame 100 in a plan view.

The second roller part 300 is disposed on the base frame 100. The second roller part 300 includes a plurality of rollers 310, a supporting part 320 supporting the rollers 310, and a connecting part 330 connecting the supporting part 320 to the base frame 100. The plurality of rollers 310 and the supporting part 320 are disposed opposite to the first roller part 200 with reference to the base frame 100 in the plan view. In an exemplary embodiment, the connecting part 230 and 330 may be alternately disposed along the first direction D1 in the plan view.

Although the transferring part includes the first to fourth conveyer line assemblies CL1, CL2, CL3 and CL4, and the first to fourth roller line assemblies RL1, RL2, RL3 and RL4 which are alternately disposed in the exemplary embodiment, the first to fourth conveyer line assemblies CL1, CL2, CL3 and CL4, and the first to fourth roller line assemblies RL1, RL2, RL3 and RL4 may be arranged in a different order.

In addition, the transferring part includes eight lines comprising four conveyer line assemblies and four roller line assemblies in the illustrated exemplary embodiment, but the invention is not limited thereto, and the transferring part may include appropriate number of conveyer line assemblies and roller line assemblies as required.

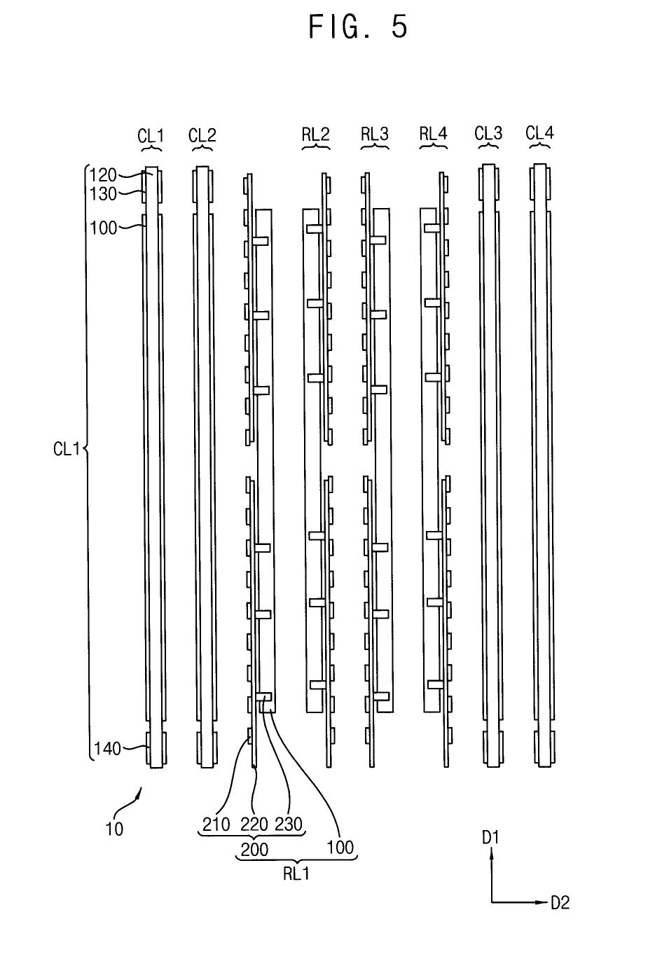

FIG. 5 is a plan view illustrating a transferring part of a substrate transferring apparatus according to still another exemplary embodiment of the invention.

Referring to FIG. 5, a transferring part includes first to fourth conveyer line assemblies CL1, CL2, CL3 and CL4, and first to fourth roller line assemblies RL1, RL2, RL3 and RL4.

The first to fourth conveyer line assemblies CL1, CL2, CL3 and CL4 are disposed at boundaries of the transferring part 10 in a second direction D2 substantially perpendicular to a first direction D1 which is a transferring direction of a substrate 2 (refers to FIG. 1).

The first to fourth roller line assemblies RL1, RL2, RL3 and RL4 are disposed in the middle portion of the transferring part 10 in the second direction D2.

Accordingly, the first conveyer line assembly CL1, the second conveyer line assembly CL2, the first roller line assembly RL1, the second roller line assembly RL2, the third roller line assembly RL3, the fourth roller line assembly RL4, the third conveyer line assembly CL3 and the fourth conveyer line assembly CL4 may be sequentially disposed in the second direction D2.

The first conveyer line assembly CL1 includes a base frame 100, a conveyer belt 120, a first pulley 130 and a second pulley 140.

The base frame 100 extends in the first direction D1. The first pulley 130 and the second pulley 140 are disposed at both end parts of the base frame 100 in the first direction D1. The conveyer belt 120 is driven by the first and second pulleys 130 and 140. The substrate 2 disposed on the conveyer belt 120 is transferred along the first direction D1, as the conveyer belt 120 is driven by the first and second pulleys 130 and 140.

The first conveyer line assembly CL1 may further include a tension maintain part maintaining tension of the conveyer belt 120.

Each of the second to fourth conveyer line assemblies CL2, CL3 and CL4 is substantially same as the first conveyer line assembly CL1.

The first roller line assembly RL1 includes a base frame 100 and a roller part 200.

The base frame 100 extends in a first direction D1. The roller part 200 may be disposed adjacent to the base frame 100. The roller part 200 includes a plurality of rollers 210, a supporting part 220 supporting the rollers 210, and a connecting part 230 connecting the supporting part 220 to the base frame 100. The plurality of rollers 210 and the supporting part 220 are parallel to the base frame 100 in a plan view.

The rollers 210 are arranged in the first direction D1, so that the substrate 2 may be transferred along the first direction D1. The rollers 210 may be idle rollers. Thus, the rollers 210 may not have driving force, but may be rotated by an external force. In an exemplary embodiment, the rollers 210 may contact to the substrate 2, and the first to fourth conveyer line assemblies CL1 to CL4 transfer the substrate 2, so that the rollers 210 may be rotated.

The second roller line assembly RL2 includes a base frame 100 and a roller part 200. The second roller line assembly RL2 is substantially same as the first roller line assembly RL1 except that the roller part is disposed opposite to the roller part 200 of the first roller line assembly RL1 with reference to the base frame 100. Thus, the roller part 200 the first roller line assembly RL1 and the roller part of the second roller line assembly RL2 may be opposite to each other or face each other.

The third and fourth roller line assemblies RL3 and RL4 are substantially same as the first and second roller line assemblies RL1 and RL2, respectively.

FIG. 6 is a perspective view partially illustrating a conveyer line assembly of a substrate transferring apparatus according to an exemplary embodiment of the invention. FIG. 7 is a cross-sectional view taken along line I-I′ of FIG. 6.

Referring to FIGS. 6 and 7, a conveyer line assembly CL of a substrate transferring apparatus includes a base frame 100, a conveyer guide 110, a conveyer belt 120, a first pulley 130 and a second pulley 140 (refers to FIG. 3).

The base frame 100 extends in the first direction D1. The base frame 100 includes a top surface 102, a first side surface 104 adjacent to the top surface 102, and a second side surface 106 opposite to the first side surface 104 and adjacent to the top surface 102. A combining groove 103 is defined in the top surface 102 of the base frame 100.

The conveyer guide 110 is disposed on the top surface 102 of the base frame 100. The conveyer guide 110 guides the conveyer belt 120.

Guide protrusions 116 are disposed in a top surface of the conveyer guide 110. The guide protrusions 116 may effectively prevent the conveyer belt 120 from leaving from the conveyer guide 110 in a second direction D2 substantially perpendicular to a first direction D1 which is a transferring direction of a substrate 2 (refers to FIG. 1). The guide protrusions 116 extend in the first direction D1 and are disposed adjacent to both end sides of the conveyer belt 120.

A combining hole 112 is defined through the conveyer guide 110. The combining hole 112 may be defined corresponding to a shape of a combining element 114, so that combining element 114 may be accommodated in the combining hole 112. In an exemplary embodiment, when the combining element 114 is a screw having a head and a body, the combining hole 112 may have a shape corresponding to the head and a portion of the body of the screw, so that the head and the portion of the body of the screw may be received in the combining hole 112.

The combining element 114 combined with the combining groove 103 of the base frame 100 through the combining hole 112 of the conveyer guide 110. In an exemplary embodiment, the combining element 114 may be a screw, and threaded rods may be provided in the combining groove 103 to be combined with threads of the screw.

The first pulley 130 and the second pulley 140 are disposed at both end parts of the base frame 100 in the first direction D1. The conveyer belt 120 is driven by the first and second pulleys 130 and 140. The substrate 2 disposed on the conveyer belt 120 is transferred along the first direction D1, as the conveyer belt 120 is driven by the first and second pulleys 130 and 140.

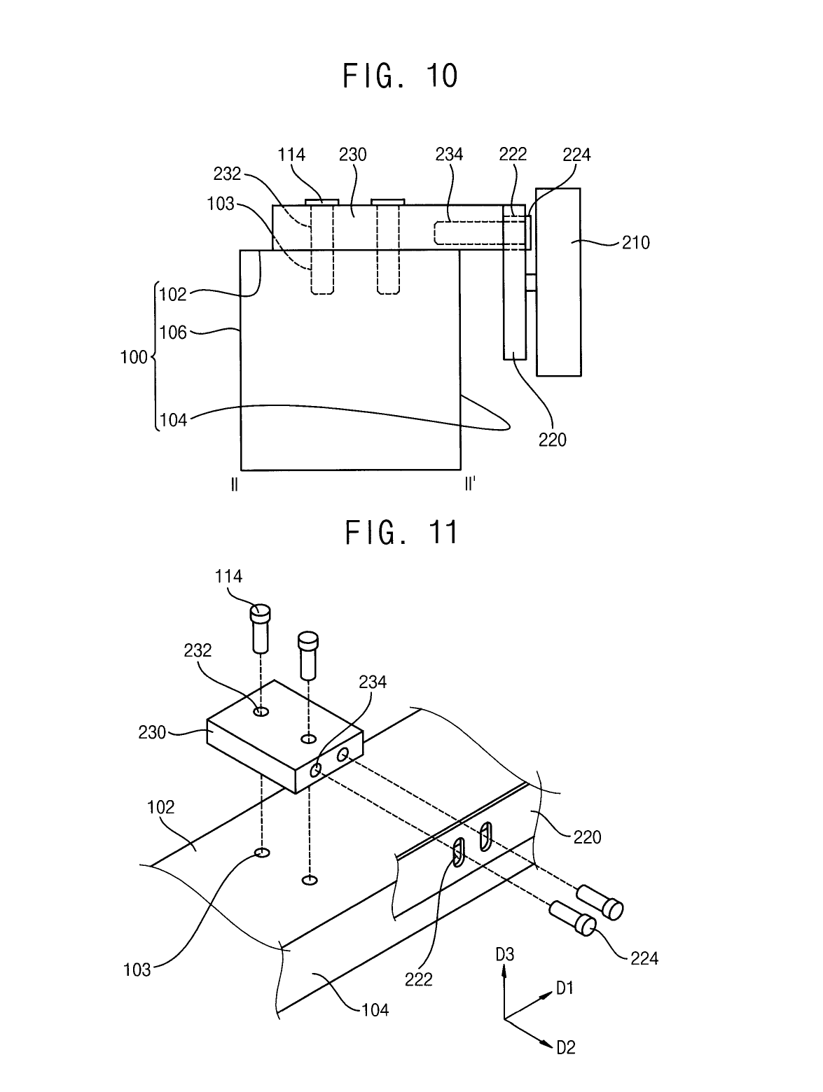

FIG. 8 is a perspective view partially illustrating a roller line assembly of a substrate transferring apparatus according to an exemplary embodiment of the invention. FIG. 9 is a side view of a roller of FIG. 8. FIG. 10 is a cross-sectional view taken along line II-IF of FIG. 8. FIG. 11 is an exploded perspective view partially illustrating the roller line assembly of FIG. 8.

Referring to FIGS. 8 and 11, a roller line assembly RL includes a plurality of rollers 210, a roller supporting part 220, a connecting part 230 and a base frame 100.

The base frame 100 extends in the first direction Dl. The base frame 100 includes a top surface 102, a first side surface 104 adjacent to the top surface 102, and a second side surface 106 opposite to the first side surface 104 and adjacent to the top surface 102 (refers to FIG. 7). A combining groove 103 is defined on the top surface 102 of the base frame 100.

A first roller part 200 (refers to FIG. 3) is disposed adjacent to a side of the base frame 100. The first roller part 200 includes the roller supporting part 220, the connecting part 230 and the rollers 210. Thus, the rollers 210 and the roller supporting part 220 may be disposed parallel to the base frame 100 in a plan view.

The roller supporting part 220 is disposed adjacent to the base frame 100, and extends in the first direction D1. The roller supporting part 220 supports the rollers 210.

The connecting part 230 connects the roller supporting part 220 to the base frame 100. The connecting part 230 may be fixed to the base frame 100 by a combining hole 112 (refers to FIG. 7) configured to fix the roller supporting part 220 to the base frame 100, and may be fixed to the roller supporting part 220 by a roller supporting part combining element 224. A relative height of the connecting part 230 and the roller supporting part 220 may be adjusted by the roller supporting part combining element 224. Detailed explanation will be mentioned later.

The rollers 210 are connected to the roller supporting part 220. The rollers 210 are arranged in the first direction D1, so that the substrate 2 may be transferred along the first direction Dl. The rollers 210 may be idle rollers. Thus, the rollers 210 may not have driving force, but may be rotated by an external force. In an exemplary embodiment, the rollers 210 may contact the substrate 2, and the first to fourth conveyer line assemblies CL1 to CL4 transfer the substrate 2, so that the rollers 210 may be rotated.

Referring to FIG. 9, the roller 210 may have a ball bearing structure. In an exemplary embodiment, the roller 210 includes an inner-side portion 212, an outer-side portion 213, a plurality of ball bearings 215 and a contacting portion 214.

A plurality of the ball bearings 215 are disposed between the inner-side portion 212 and the outer-side portion 213 surrounding the inner-side portion 212. Accordingly, as the roller 210 rotates with reference to a rotational axis 211, a rotational friction force may be decreased by the ball bearings 215 between the inner-side portion 212 and the outer-side portion 213. Thus, the rotational friction force of roller 210 may be decreased when the substrate 2 is transferred with contacting to the roller 210, so that slip between the substrate 2 and the roller 210 may be decreased.

In an exemplary embodiment, the ball bearings 215 may include metal. The ball bearings 215 may include an alloy including carbon (C), manganese (Mn), silicon (Si), phosphorus (P), sulfur (S), chrome (Cr), nickel (Ni) and/or nitrogen (N), for example. In an exemplary embodiment, the ball bearing 215 may include austenitic stainless steel such as SUS304. The inner-side portion 212 and the outer-side portion 213 may include metal. In an exemplary embodiment, the inner-side portion 212 and the outer-side portion 213 may include austenitic stainless steel such as SUS304.

The contacting portion 214 may be disposed on the outer-side portion 213. The contacting portion 214 makes contact with the substrate 2, and may include a material for preventing static electricity. In an exemplary embodiment, the contacting portion 214 may include ultra-high-molecular-weight polyethylene (“UHMW-PE”).

Although the contacting portion 214 is disposed on the outer-side portion 213 in the exemplary embodiment, the outer-side portion 213 may directly make contact with the substrate 2 without the contacting portion 214. In this case, the outer-side portion 213 may include anti-static material. In an exemplary embodiment, the outer-side portion 213 may include UHMW-PE.

Referring to FIGS. 10 and 11, a combining hole 232 and an adjusting groove 234 are defined in the connecting part 230. The combining hole 232 is defined through the connecting part 230. The adjusting groove 234 is defined in a side surface of the connecting part 230 which makes contact with the roller supporting part 220.

A combining element 114 is combined with the combining groove 103 of the base frame 100 through the combining hole 232 of the connecting part 230. In an exemplary embodiment, the combining element 114 may be a screw, and threaded rods may be provided in the combining groove 103 to be combined with threads of the screw.

An adjusting hole 222 is defined on the roller supporting part 220. The adjusting hole 222 may be defined corresponding to the adjusting groove 234 of the connecting part 230, and may have an ellipse shape having a long axis in a third direction D3 (refers to FIG. 11) which is substantially perpendicular to the first and second directions D1 and D2.

The roller supporting part combining element 224 is combined with the adjusting groove 234 of the connecting part 230 through the adjusting hole 222 of the roller supporting part 220. In an exemplary embodiment, the roller supporting part combining element 224 may be a screw, and threaded rods may be provided in the adjusting groove 234 to be combined with threads of the screw. The adjusting hole 222 have the ellipse shape having the long axis in the third direction D3, so that a position of the roller supporting part 220 may be adjusted along the third direction D3 with reference to the connecting part 230. Thus, positions of the rollers 210 may be adjusted to contact with the substrate 2. The roller part may further include additional connecting parts. Accordingly, positions of the roller supporting part 220 may be adjusted, so that the rollers 210 may uniformly contact to the substrate 2.

Although the roller line assembly RL includes one roller part in the illustrated exemplary embodiment, the roller line assembly RL may include a plurality of roller parts such as a first roller line assembly RL1 of FIG. 3.

In addition, a base frame 100 of the roller line assembly RL and the combining element 114 are substantially same as base frame 100 of a conveyer line assembly CL and a combining element 114 of FIG. 6. Thus, the conveyer line assembly CL may be converted into the roller line assembly RL as occasion demands, by removing a conveyer belt 120, first and second pulleys 130 and 140 and a conveyer guide 110 (refers to FIG. 6), and combining the connecting part 230 and the roller part to the base frame 100. In addition, similarly, the roller line assembly RL may be converted into the conveyer line assembly CL.

According to the present invention, a substrate transferring apparatus may include an electrostatic discharge wire and/or an ionizer. Thus, static electricity disposed on the substrate 2 may be effectively prevented.

In addition, the substrate transferring apparatus may include a plurality of roller line assemblies, so that damage to the substrate by a conveyer belt may be decreased.

In addition, the roller line assembly may be disposed in the middle portion of the transferring part, so that a portion of the substrate not contacting the conveyer belt may be maximized

In addition, the conveyer line assembly and the roller line assembly may be converted each other, due to a parts sharing.

In addition, rollers of the roller line assembly may include an anti-static material to decrease static electricity and damage on the substrate.

In addition, the rollers may have a ball bearing structure to decrease slip on the substrate.

In addition, positions of the rollers of the roller line assembly may be adjusted by an adjusting groove of a connecting part, an adjusting hole of a roller supporting part and a roller supporting part combining element, so that the rollers may uniformly contact to the substrate.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A substrate transferring apparatus comprising:
a first conveyer line assembly which transfers a substrate in a first direction, and comprises:
a first base frame extending along the first direction;
first and second pulleys respectively disposed at both end parts of the first base frame in the first direction; and
a conveyer belt disposed on the first base frame, and driven by the first and second pulleys; and
a first roller line assembly spaced apart from the first conveyer line assembly in a second direction which is substantially perpendicular to the first direction, and comprising:
a second base frame extending along the first direction; and
a first roller part connected to the second base frame and comprising a plurality of rollers which contacts the substrate.

2. The substrate transferring apparatus of claim 1, further comprising:
second to fourth conveyer line assemblies spaced apart from the first conveyer line assembly in the second direction; and
second to fourth roller line assemblies spaced apart from the first roller line assembly in the second direction.

3. The substrate transferring apparatus of claim 2, wherein each of the second to fourth conveyer line assemblies comprises the first base frame, the first and second pulleys and the conveyer belt, and each of the second to fourth roller line assemblies comprises the second base frame and the first roller part.

4. The substrate transferring apparatus of claim 3, wherein
the first and second conveyer line assemblies are disposed directly adjacent to each other as a pair,
the third and fourth conveyer line assemblies are disposed directly adjacent to each other as a pair, and
the first to fourth roller line assemblies are disposed between the pair of the first and second conveyer line assemblies and the pair of the third and fourth conveyer line assemblies.

5. The substrate transferring apparatus of claim 4, further comprises a working part which removes protecting films on top and bottom surfaces of the substrate, and
the substrate without the protecting films is transferred by the first to fourth conveyer line assemblies.

6. The substrate transferring apparatus of claim 1, wherein the first roller part of the first roller line assembly further comprises:
the plurality of rollers arranged in the first direction;
a roller supporting part disposed adjacent to the second base frame, and extending along the first direction; and
a connecting part connecting the roller supporting part to the second base frame.

7. The substrate transferring apparatus of claim 6, wherein the first roller line assembly further comprises a second roller part opposite to the first roller part with reference to the second base frame, and the second roller part comprises the plurality of rollers, the roller supporting part and the connecting part.

8. The substrate transferring apparatus of claim 6, further comprising:
a loading part disposed adjacent to the conveyer line assembly in the first direction; and
an un-loading part disposed opposite to the loading part with reference to the conveyer line assembly and adjacent to the conveyer line assembly,
wherein the substrate is transferred in an order of the loading part, the first conveyer line assembly and the un-loading part.

9. The substrate transferring apparatus of claim 8, further comprising an ionizer which supplies ion to the substrate.

10. The substrate transferring apparatus of claim 8, further comprising an electrostatic discharge wire disposed between the loading part and the first conveyer line assembly, and spaced apart from a bottom surface of the substrate, and
wherein the electrostatic discharge wire extends in the second direction corresponding to a length of the substrate in the second direction, and comprises an electro-conductive fiber or anti-static fiber.

11. The substrate transferring apparatus of claim 6, wherein the plurality of rollers of the first roller part of the first roller line assembly are idle rollers.

12. The substrate transferring apparatus of claim 11, wherein each of the plurality of rollers comprises a contacting part surrounding the roller and contacting the substrate, and
the contacting part comprises ultra-high-molecular-weight polyethylene.

13. The substrate transferring apparatus of claim 12, wherein each of the plurality of rollers further comprises:
an inner-side portion having a rotational axis,
an outer-side portion surrounding the inner-side portion, and
a plurality of ball bearings disposed between the inner-side portion and the outer-side portion.

14. The substrate transferring apparatus of claim 6, wherein the first base frame of the first conveyer line assembly and the second base frame of the first roller line assembly are substantially same as each other.

15. The substrate transferring apparatus of claim 14, wherein the first roller line assembly further comprises:
a combining groove defined in the second base frame;
a combining hole defined through the connecting part; and
a combining element combined with the combining groove through the combining hole, and configured to fix the connecting part to the second base frame.

16. The substrate transferring apparatus of claim 15, wherein an adjusting groove is defined in a surface of the connecting part which contacts the roller supporting part,
an adjusting hole is defined through the roller supporting part, and
a roller supporting part combining element is combined with the adjusting groove through the adjusting hole, and configured to fix the roller supporting part to the connecting part.

17. The substrate transferring apparatus of claim 16, wherein the adjusting hole has a long side in a third direction which is substantially perpendicular to the first and second directions.

18. The substrate transferring apparatus of claim 15, wherein the first conveyer line assembly further comprises a conveyer guide dispose between the first base frame and the conveyer belt to prevent the conveyer belt from leaving.

19. The substrate transferring apparatus of claim 18, wherein a combining hole is defined through the conveyer guide, and the conveyer guide comprises a combining element combined with a combining groove of the first base frame through the combining hole of the conveyer guide.

20. The substrate transferring apparatus of claim 18, wherein the conveyer guide further comprises guide protrusions provided adjacent to both end parts of the conveyer belt in the second direction to prevent the conveyer belt from being leaving from the conveyer guide in the second direction.
